(19) United States
(12) Patent Application Publication
(10) Pub. No.: US 2023/0220702 A1
(43) Pub. Date: Jul. 13, 2023

(54) OVERLOAD PROTECTION FOR A LOCK STRUCTURE

(71) Applicant: Essity Hygiene and Health Aktiebolag, Goteborg (SE)

(72) Inventors: Mark W. Henson, Harrodsburg, KY (US); Per Möller, BORLÄNGE (SE); Karl Walheim, BORLÄNGE (SE)

(21) Appl. No.: 18/010,445

(22) PCT Filed: Jun. 22, 2020
(86) PCT No.: PCT/SE2020/050643

§ 371 Date: Dec. 14, 2022

(51) Int. Cl. E05B 17/00; E05B 65/00; E05C 3/14; A47K 10/32; A47K 5/12

(52) U.S. Cl. CPC E05B 17/0058; E05B 65/00; E05C 3/145; A47K 10/32; A47K 5/12; A47K 2010/3246

(57) ABSTRACT

A lock structure is provided for use with a dispenser comprising a housing have an interior volume for holding a dispensable product, the housing having openable part for providing access to the interior of the housing. The lock structure has a lock housing, a latch operable between a locked position and an unlocked position, a lock cylinder structure comprising a rotation means insert portion, and a resilient member for biasing the latch toward the locked position. The lock structure is provided with an overload protection mechanism formed by a resilient obstruction positioned to define an extreme position that corresponds to the locked or unlocked position of the latch and is adapted to give way upon experiencing an overload force to allow the lock cylinder structure to rotate beyond the extreme position.

### CROSS REFERENCE TO RELATED APPLICATION

This application is a National Stage application of PCT/SE2020/050643, filed Jun. 22, 2020, which is incorporated by reference in its entirety herein.

### FIELD

The present disclosure relates to overload protection for a lock structure, and particularly a lock structure for use with a dispenser having an openable part for providing access to an interior of the dispenser that may contain a dispensable product.

### BACKGROUND

Dispensers for some consumable products, such as paper towel products, liquid soap, and the like, may require access to the interior of the dispenser in order to be able to remove or refill the product periodically. Depending on where the dispenser is located, such as in a public area, it may be further required that the dispenser be locked to prevent unauthorized persons from having access to remove the entire contents of the dispenser. In this case, authorized persons will have access to a key for unlocking the dispenser.

Sometimes in operation a user seeking to move the lock between the locked and unlocked configurations may apply a rotational force that is too high, e.g., an overload force, to the key inserted within the lock structure. The application of such a rotational force can in turn cause the lock structure to break or at least result in some damage to the lock structure.

### SUMMARY

It would be desirable, accordingly, to provide overload protection for a lock structure that minimizes or avoids damage to the lock structure when the lock structure is forced to rotate beyond a predetermined position.

In one embodiment, a lock structure is provided that has an overload protection mechanism formed by at least one resilient obstruction. The at least one resilient obstruction is positioned to define an extreme position for a part of the lock structure, which may correspond to a locked or unlocked position, and is adapted to give way when an overload force is sensed such that the part of the lock structure is permitted to move beyond the extreme position.

The disclosure provides a lock structure for locking an openable part of a dispenser having an interior volume for holding a dispensable product, comprising a lock housing, a latch operable between a locked position and an unlocked position, a lock cylinder structure, and a resilient member biasing the latch towards the locked position. The lock housing comprises a central annular opening in which the lock cylinder structure is rotatably housed. The lock cylinder structure comprises a rotation means insert portion for receiving a rotation means, such as for example a key, and the lock cylinder structure is adapted to be rotated by means of the rotation means. The lock structure is provided with an overload protection mechanism formed by at least one resilient obstruction, which is positioned to define an extreme position for a part of the lock cylinder or the rotation means inserted therein, the extreme position corresponding to the unlocked or locked position of the latch. The overload protection mechanism is adapted to give way to the part of the lock cylinder or the rotation means inserted therein upon experiencing an overload force thereby allowing the part of the lock cylinder or the rotation means inserted therein to move beyond the extreme position.

In embodiments according to the disclosure, the overload protection member may comprise a first set of resilient obstructions that are arranged to interlock the lock cylinder structure or the rotation means inserted therein with the latch and release the latch from the lock cylinder structure or the rotation means inserted therein upon experiencing the overload force.

In embodiments, the latch may be adapted for the being engaged by the rotation means inserted into the lock cylinder structure for said operation between the locked position and the unlocked position.

In embodiments, the latch may be adapted for the being engaged by the rotation means inserted into the lock cylinder structure for said operation between the locked position and the unlocked position.

In particular embodiments, the lock cylinder structure comprises a lock cylinder base, to which the latch is connected and a lower ring to which the insert portion is connected. The lower ring is configured to rotatably engage with the lock cylinder base. The lower ring comprises two annular protrusions spaced apart from each other along the circumference of the lower ring. The first set of resilient obstructions are arranged on the lock cylinder base to engage the annular protrusions and thereby block the rotation of the lower ring with respect to the lock cylinder base.

In embodiments according to the disclosure, the annular protrusions may be spaced 180° apart along the circumference of the lower ring of the lock cylinder structure.

In embodiments according to the disclosure, the overload protection mechanism may comprise a second set of resilient obstructions that are arranged to define the extreme positions of the lock cylinder structure with respect to the lock housing.

In embodiments according to the disclosure, the key insert portion may comprise an annular top member having a topside and a bottomside. The topside comprises a slot adapted to receive a key and the bottomside comprises two protrusion members spaced from each other along a portion of a peripheral edge of the bottomside. The second set of resilient obstructions are provided on the lock housing to obstruct the protrusion members and thereby block rotation of the key insert portion beyond the extreme positions.

In embodiments according to the disclosure, the protrusion members may be disposed on opposite sides of the peripheral edge of the bottomside of the top member.

In embodiments according to the disclosure, the protrusion members may be spaced approximately 180° apart along the circumference of the peripheral edge of the bottomside of the top member.

In embodiments according to the disclosure, the second set of resilient obstructions may be provided along an interior annular surface of the lock housing, spaced apart by approximately 135°. The second set of resilient obstructions are configured to allow rotation of the key insert portion between two extreme positions of the lock cylinder structure, which correspond to the locked and unlocked positions of the latch.

In embodiments according to the disclosure, each resilient obstruction may be a resiliently deformable part. The resiliency may be achieved by a combination of a choice of a material, which is resiliently deformable, and design and/or dimensions of the resilient obstructions.

In embodiments according to the disclosure, the parts of the lock structure comprising one or a set of resilient obstructions may be moulded parts made of a suitable thermoplastic material. Suitable thermoplastic materials are well-known to the skilled person. In alternative embodiments, the at least one resilient obstruction may also be embodied as, for example, a spring-mounted part, a bent metal part such as a leaf spring, or in other ways.

In embodiments according to the disclosure, each resilient obstruction may comprise one side having a steep slope defining the extreme position for that part of the lock structure and another side having a lesser slope, such that when that part of the lock structure has passed by the resilient obstruction as a result of the overload force, it is allowed to be moved back past the obstruction in the opposite direction with little or no obstruction.

In particular embodiments, the rotation means insert portion is a key insert portion for receiving a key as the rotation means for rotating the lock cylinder structure and possibly the latch. Other rotation means are envisaged within the scope of the present disclosure, namely in general any insert part which is adapted for being inserted into and/or mating with the lock cylinder structure and possibly the latch and by which the latch is operable from the locked position to the unlocked position.

### BRIEF DESCRIPTION OF THE DRAWINGS

The present disclosure will be discussed in more detail below, with reference to the attached drawings.

FIG. 1 shows a schematic view of an exemplary lock structure.

FIG. 2 shows an exploded view of an embodiment of the lock structure.

FIGS. 3a and 3b show perspective and front views, respectively, of an exemplary key insert.

FIG. 4 shows a schematic view of an exemplary key-insert and lock cylinder of the lock cylinder structure.

FIG. 5 shows a cross sectional view of the key-insert and lock cylinder taken along the plane V-V of FIG. 4.

FIG. 6 shows a top view of an exemplary lock housing.

FIG. 7 shows a cross section of an exemplary lock cylinder structure, taken along the plane VII-VII in FIG. 1.

FIGS. 8a and 8b show schematic views of an exemplary overload protection mechanism.

FIG. 9 shows a schematic view of the bottom of an exemplary lock cylinder and lock cylinder base.

FIG. 10 shows a schematic view of an exemplary lock cylinder base and latch.

FIGS. 11a and 11b show schematic views of an exemplary overload protection mechanism.

### DESCRIPTION OF EMBODIMENTS

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure may operate in other sequences than described or illustrated herein.

Moreover, the terms top, bottom, over, under and the like in the description and the claims are used for descriptive purposes and not necessarily for describing absolute positions. The terms so used are interchangeable under appropriate circumstances and the embodiments of the disclosure described herein may operate in other orientations than those described or illustrated herein.

Furthermore, the various embodiments, although referred to as “preferred” are to be construed as exemplary manners in which the disclosure may be implemented rather than as limiting the scope of the disclosure.

Different aspects of the present disclosure will be described more fully hereinafter with reference to the attached drawings. The embodiments disclosed herein may, however, be realized in many different forms and should not be construed as being limited to the aspects set forth herein.

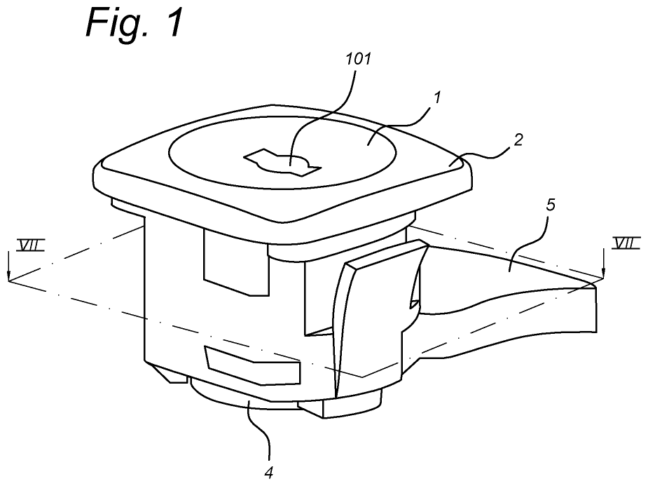

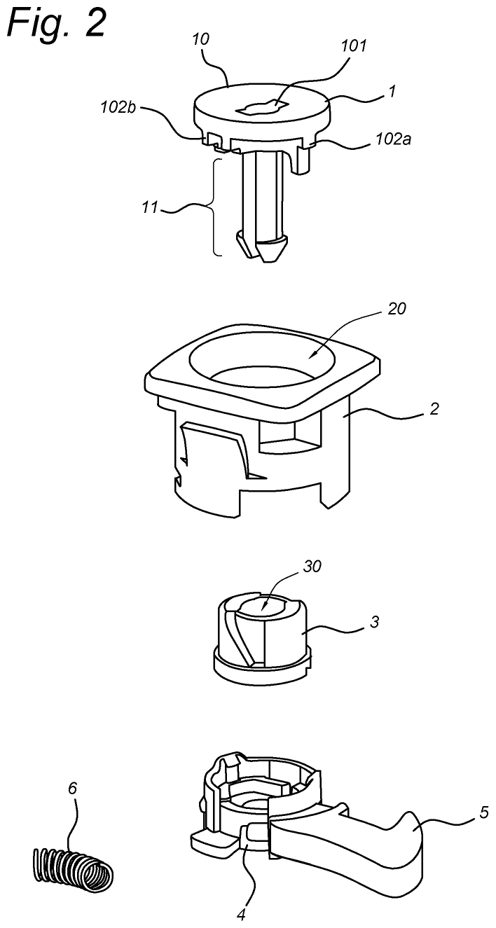

FIG. 1 is a schematic view of an assembled embodiment of the lock structure according to the present disclosure. A key insert 1 comprising a slot 101 for receiving a key is fit into and enclosed by housing 2. The key insert 1 may be interlocked with a lock cylinder 3 (see FIG. 2) forming a lock cylinder structure, which is received by and fitted in a central annular opening 20 of the housing 2. The lock cylinder structure further comprises a lock cylinder base 4 to which the key insert 1 and lock cylinder 3 are rotatably connected. A small portion of the lock cylinder base 4 may be observed below the housing 2 in FIG. 1. A latch 5, which may be controlled between a locked position and unlocked position by operation of a key received in the key insert 1, may be positioned to extend transversely from the lock cylinder base 4.

FIG. 2 is an exploded view of an embodiment of a lock structure. The lock structure comprises a key insert 1, housing 2, lock cylinder 3, lock cylinder base 4, latch 5, and resilient member 6. The key insert 1 is adapted to be inserted through a central annular opening 20 in the housing 2 and connected with the lock cylinder 3. The key insert 1 may be releasably connected with the lock cylinder 3 by means of a snap-fit connection. The key insert 1 also comprises a slot 101 for receiving a key and protrusion members 102a and 102b, which are configured to interface with an interior of the housing 2. The housing 2 is configured to enclose the lock cylinder 3 together with the key insert 1 within the central annular opening 20. The housing 2 may be further configured to enclose at least a portion of the lock cylinder base 4 and/or resilient member 6.

In FIG. 2, the key insert 1, the lock cylinder 3 and lock cylinder base 4 including latch 5 are shown as separate pieces that are to be assembled together. In alternative embodiments, some or all of these pieces may be formed together as a unitary component, or alternatively as individual components that are subsequently assembled together. Also, lock cylinder base 4 and latch 5 are shown as a unitary piece, but alternatively the latch 5 may be a separate piece configured to be attached to at least a portion of the lock cylinder base 4. The lock cylinder base 4 is further adapted such to house at least a portion of the resilient member 6 therein so that the resilient member 6 is positioned to bias the latch 5 towards a locked position.

The exemplary key insert 1 shown in FIG. 2 comprises a top member 10 and a longitudinal connector 11. The top member 10 comprises a slot 101 for receiving a key and protrusion members 102a and 102b that interface with an interior of the housing 2. The longitudinal connector 11 is configured to engage with the lock cylinder 3 and form a releasable snap-fit connection therewith. More specifically, the longitudinal connector 11 is configured to be inserted into the top of the lock cylinder 3 through a bore 30 therein and form a snap-fit connection with the bottom of the lock cylinder structure.

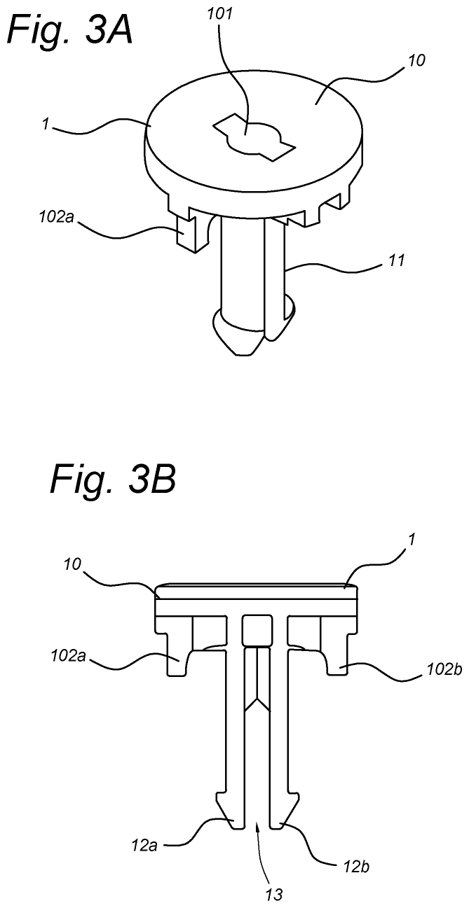

FIGS. 3a and 3b depict an exemplary key insert 1. FIG. 3a is a perspective view of the key insert 1. As described herein, the key insert 1 comprises an annular top member 10 having a topside and bottomside and a longitudinal connector 11. The topside of the annular member 10 further comprises a slot 101 adapted for receiving a key and the bottomside of the annular member 10 further comprises protrusion members 102a and 102b spaced apart along a portion of a peripheral edge of the bottomside.

FIG. 3b shows a front profile view of the key insert 1. Protrusion members 102a and 102b are shown spaced apart and disposed on opposite sides of a peripheral edge of the bottomside of the top member 10 and extend perpendicularly therefrom along a portion of the length of the longitudinal connector 11. The protrusion members 102a and 102b are, in this example embodiment, spaced 180° apart along the peripheral edge of the bottomside of the top member 10.

The longitudinal connector 11 of the key insert 1 comprises first and second connector arms 12a and 12b separated along a portion of the length of the longitudinal connector 11 by a central groove 13. As shown in FIG. 3b, the first and second connector arms 12a and 12b are parallel with each other along the length of the longitudinal connector 11. The first and second connector arms 12a and 12b are configured to be biased radially inward toward the central groove 13 of the longitudinal connector 11 when the longitudinal connector 11 is inserted into the lock cylinder 3. The first and second connector arms 12a and 12b are also configured to be biased radially inward toward the central groove 13 even after the longitudinal connector 11 has been inserted into and snap-fit connected together with the lock cylinder 3 so as to facilitate the release of the snap-fit connection and permit removal of the longitudinal connector 11 from the lock cylinder 3.

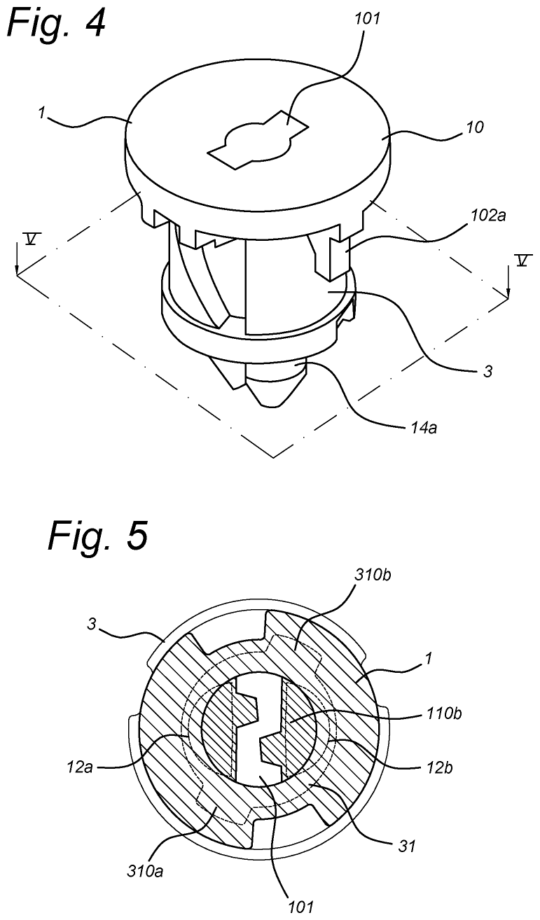

FIG. 4 shows a key insert 1 and lock cylinder 3 of the lock structure. In this view, the key insert 1 is shown attached to the lock cylinder 3. The longitudinal connector 11 of the key insert 1 has been inserted through the entire length of the bore 30 of the lock cylinder 3 and the first and second connector arms 12a and 12b may be seen below the bottom of the lock cylinder 3. As discussed above, the first and second connector arms 12a and 12b are biased radially inward toward the central groove 13 of the longitudinal connector 11. Biasing the first and second connector arms 12a and 12b radially inward toward the central groove 13 thus permits the longitudinal connector 11 to be released and removed back through the bore 30 of the lock cylinder 3.

FIG. 5 shows a cross-section of the key insert 1 and lock cylinder 3 of FIG. 4, taken generally along plane V-V in FIG. 4. The bottom of lock cylinder 3 comprises a lower ring 31 having annular protrusions 310a and 310b. The lower ring 31 provides an abutment for respective steps 14a and 14b formed on the first and second connector arms 12a and 12b that prevents the key insert 1 from being removed back through the bore 30. In the embodiment shown, the key insert 1 is configured to be removable from the lock cylinder structure and may be removed by biasing the second connector arms 12a and 12b radially inward toward the central groove to permit the steps 14a and 14b to clear the lower ring 31. In alternative embodiments, the key insert 1 may also be a non-removable piece and may for example be permanently interlocked with or be an integral part of the lock cylinder 3.

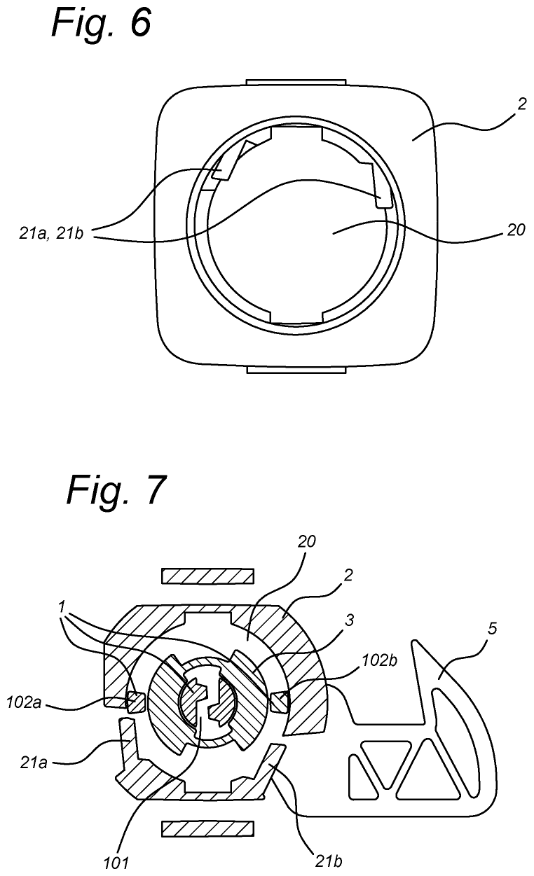

FIG. 6 is a top view of an exemplary lock housing 2 of the lock structure of the present disclosure. The lock housing 2 comprises a central annular opening 20. The housing 2 also comprises a set of resilient obstructions 21a and 21b, which are provided along an interior annular surface of the lock housing 2. The resilient obstructions 21a and 21b are spaced apart along the interior annular surface, for example by approximately 135°. The resilient obstructions 21a and 21b are arranged to obstruct the protrusion members 102a and 102b on the peripheral edge of the top member 10 of the key insert 1 and thereby block the key insert 1 from rotating beyond an extreme position. More particularly, the arrangement of the resilient obstructions 21a and 21b in the lock housing 2 defines the extreme positions of the lock cylinder structure, which correspond to the locked and unlocked positions of the latch 5. Rotation of the key insert 1 between the two defined extreme positions i.e., between the locked and unlocked positions of the latch 5, is not inhibited by the resilient obstructions 21a and 21b. As may be appreciated from FIG. 6 and FIG. 7, the resilient obstructions 21a, 21b penetrate the circular bore 20 of the housing (and thus into the circular path of the protrusion members 102a, 102b). The resilient obstructions 21a, 21b have one side forming a steep slope or relatively strong obstruction with respect to the respective protrusion member 102a, 102b, and the other side forming a lesser slope or little or no obstruction. The side with the steep slope defines the respective extreme position for the protrusion member while still allowing the protrusion member to push the resilient obstruction 21a, 21b away when the overload force is applied. The side with the lesser slope allows the obstruction member 21a, 21b that has passed by the respective obstruction into the zone in between the resilient obstructions to be moved back into the normal operation zone with little or no obstruction.

In operation, a user inserts a key into slot 101 and applies a force to rotate the key together with the lock cylinder structure to move the latch 5 between the locked and unlocked positions. During normal operation, the force applied by the user to rotate the key and lock cylinder structure is insufficient to cause the lock cylinder structure to rotate beyond an extreme position. When the force applied by the user to rotate the key and the lock cylinder structure is an overload force sufficient to cause the lock cylinder structure to rotate beyond a predetermined extreme position, the respective resilient obstruction member 21a and 21b in contact with and obstructing rotational movement of one of protrusion members 102a, 102b on the key insert 1 is configured to give way, permitting the protrusion member 102a, 102b to pass. The key insert is therefore allowed to continue to rotate to make a 180° turn and snap back into a working position. Moreover, the resilient obstruction members 21a and 21b being configured to give way to the protrusion members 102a, 102b when an overload force is applied to the key and lock cylinder structure to force the lock cylinder structure beyond an extreme position avoids or at least minimizes the possibility of damaging and/or breaking the lock structure.

The cross-section shown in FIG. 7 is taken along the plane VII-VII in FIG. 1, at the level of the resilient obstruction members 21a and 21b, and shows the lock housing 2, key insert 1, lock cylinder 3, and lock cylinder base 4 to which latch 5 is connected. As may be seen in FIG. 7, lock cylinder 3 is positioned in the center of the central annular opening 20 of the housing 2. Protrusion members 102a and 102a of the key insert 1 may be seen on opposing sides of the lock cylinder 3 and are shown to be spaced approximately 180° apart.

When a user inserts a key into the slot 101 and applies a force to rotate the key and lock cylinder structure in a counterclockwise (“CCW”) direction, protrusion member 102a will be obstructed from rotating further once it comes into contact resilient obstruction member 21a. If, however, the force applied by the user is an overload force, resilient obstruction member 21a will give way thus allowing protrusion member 102a to pass and continue rotating around the central annular opening 20 until the lock cylinder structure has rotated 180° and the key insert 1 has snapped back into a working position. Similarly, when a user inserts a key into the slot 101 and applies a force to rotate the key and lock cylinder structure starting from the working position in a clockwise (“CW”) direction, protrusion member 102b will be obstructed from rotating further once it comes into contact with resilient obstruction member 21b. Again, if the force applied by the user is an overload force, resilient obstruction member 21b will give way thereby allowing protrusion member 102b to pass and continue rotating around the central annular opening 20. The lock cylinder structure will be able to rotate 180° so that the key insert 1 may snap back into a working position.

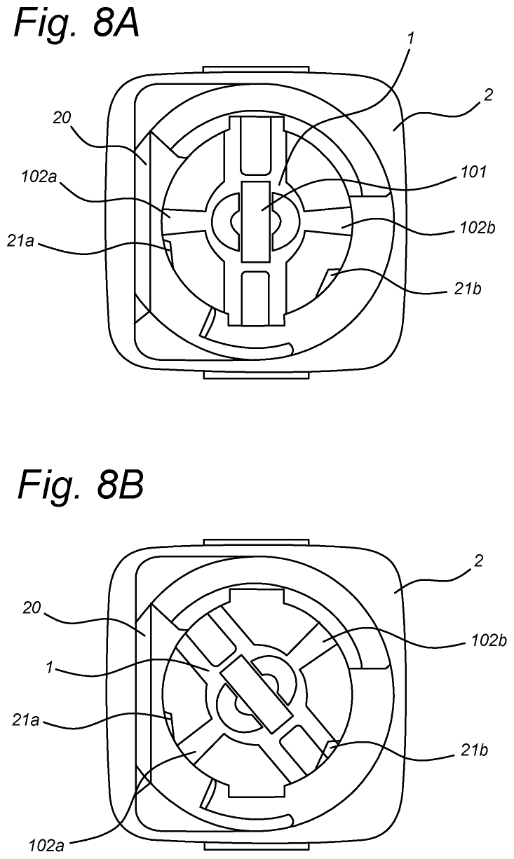

FIGS. 8a and 8b illustrate the operation of an overload protection mechanism of a lock structure according to the present disclosure. The lock cylinder structure comprising the key insert 1 and lock cylinder 3 is disposed in the central annular opening 20 of the lock housing 2 in both figures. In FIG. 8a, the key insert 1 is shown to be in a working position. When a key is inserted into the slot 101 and a user applies a force to rotate the key and lock cylinder structure in a CCW direction, protrusion member 102a will rotate until it comes into contact with resilient obstruction member 21a. If the force applied by the user to rotate the key and lock cylinder structure is insufficient to cause the lock cylinder structure to rotate beyond an extreme position i.e., the force applied is not an overload force, the protrusion member 102a will be obstructed from rotating past the resilient obstruction member 21a.

FIG. 8b depicts the position of the lock cylinder structure in the lock housing 2 shortly after an overload force has been applied to rotate the key and lock cylinder structure. Here, protrusion member 102a is shown to have passed resilient obstruction member 21a when rotated in a CCW direction with an overload force. As discussed above, when the force applied by the user to rotate the key and the lock cylinder is an overload force, resilient obstruction member 21a will give way and permit the protrusion member 102 to pass so that the lock cylinder structure may continue rotating in the lock housing 2.

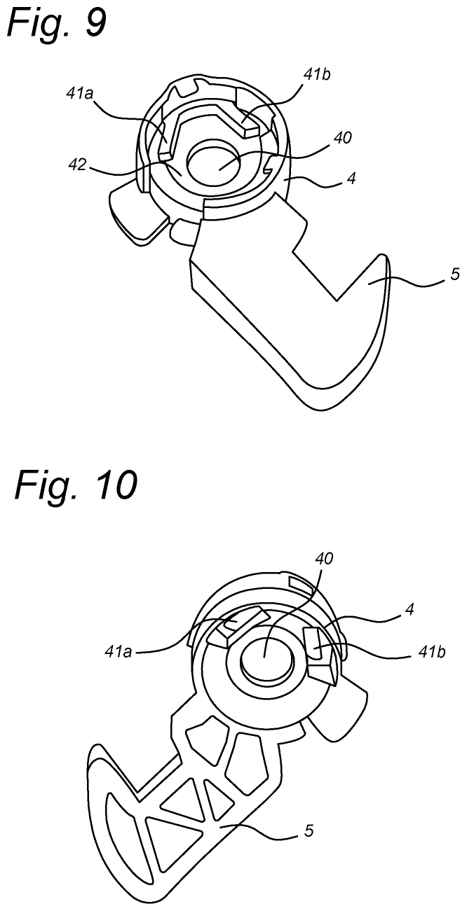

In FIG. 9, an example lock cylinder base 4 and latch 5, of a lock structure according to the present disclosure, are shown as a unitary piece. The lock cylinder base comprises a central annular opening 40 and an overload protection mechanism. The overload protection mechanism of FIG. 9 comprises resilient obstructions 41a and 41b, which are spaced apart along an interior annular surface 42 of the lock cylinder base 4. Though not shown in FIG. 9, the lock cylinder structure, in particular the lock cylinder 3, is configured to engage with the lock cylinder base 4 in such a way that the lock cylinder 3 is rotatable along the interior annular surface 42 of the lock cylinder base 4.

FIG. 10 is a bottom view of the lock cylinder base 4 and lock cylinder 3. The lock cylinder 3 comprises a top and bottom and has a centralized bore 30 through its core. The bore 30 may extend along a central longitudinal axis of the lock cylinder 3 from the top through the bottom of the lock cylinder 3. The bottom of the lock cylinder 3 comprises a lower ring 31 that encircles the bore 30. The lower ring 31 further comprises two annular protrusions 310a and 310b that are spaced apart along the circumference of the lower ring 31. The annular protrusions 310a and 310b may for example be spaced 180° apart in embodiments of the lock assembly.

The lower ring 31 of the lock cylinder 3 is configured to engage with the lock cylinder base 4. In operation when the lock cylinder 3 is engaged with the lock cylinder base 4, the lock cylinder is rotatable with respect to the lock cylinder base 4 along the interior annular surface 42. The annular protrusions 310a and 310b are arranged to come into contact with the respective resilient obstructions 41a and 41b on the lock cylinder base 4 when a key is inserted into the key insert 1 and rotated, causing the lock cylinder structure, and in particular the lock cylinder 3, to rotate to move the latch 5 between the unlocked and locked positions. Thus, during normal operation of the lock structure, when the force applied to rotate the lock cylinder structure is insufficient to cause the lock cylinder structure to rotate beyond an extreme position, the annular protrusions 310a and 310b do not rotate past the resilient obstructions 41a and 41b. As may be appreciated from FIG. 9 and FIG. 10, the resilient obstructions 41a, 41b penetrate into the circular recess of the lock cylinder base 4 where the lower ring 31 of the lock cylinder 3 is received (and thus into the circular path of the annular protrusion members 310a, 310b). The obstructions 41a, 41b have one side forming a steep slope or relatively strong obstruction with respect to the respective annular protrusion member 310a, 310b, and the other side forming a lesser slope or little or no obstruction. The side with the steep slope defines the respective extreme position for the annular protrusion while still allowing the annular protrusion member to push the resilient obstruction 41a, 41b away when the overload force is applied. The side with the lesser slope allows the annular protrusion member 310a or 310b that has passed by the respective resilient obstruction 41a or 41b into the zone in between the resilient obstructions to be moved back into the normal operation zone with little or no obstruction.

When the force applied by a user to rotate the key and the lock cylinder structure is an overload force i.e., a force sufficient to cause the lock cylinder structure to rotate beyond a defined extreme position, the respective resilient obstructions 41a and 41b in contact with and obstructing the rotational movement of one of annular protrusion members 310a, 310b on the lower ring 31 are configured to give way so that the lock cylinder 3 may continue to rotate within the interior annular surface 42 of the lock cylinder base 4. In this regard, the resilient obstructions 41a and 41b allow the latch 5 to be temporarily disconnected from the lock cylinder 3 as it rotates 180° with the key insert 1 to permit the key insert 1 to be snapped back into a working position. This prevents the latch 5 from being rotated 180° along with the lock cylinder 3 and the rest of the lock cylinder structure when the overload force is applied. This in turn avoids or at least minimizes the possibility of damaging and/or breaking the lock structure when an overload force is applied to force the lock cylinder structure beyond an extreme position.

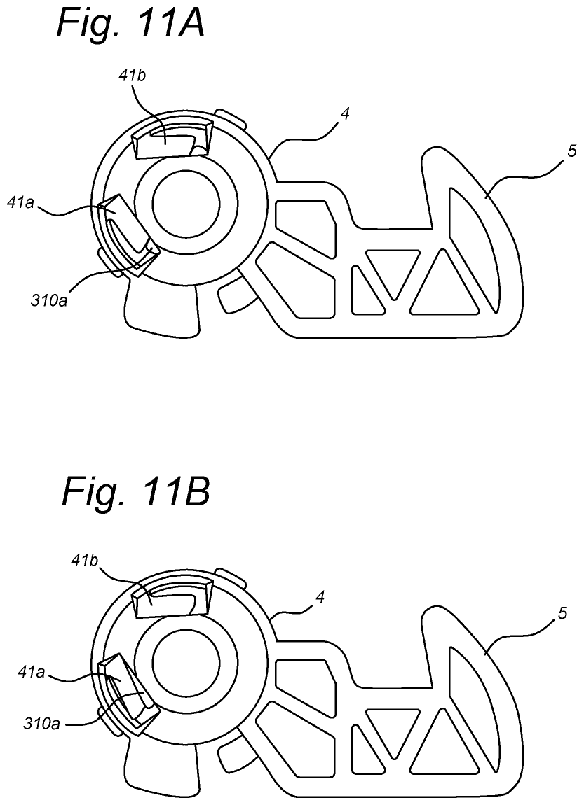

FIGS. 11a and 11b each depict a bottom view of a lock structure and illustrate the operation of the overload protection mechanism in the lock cylinder base 4. The lock cylinder structure, which includes the key insert 1 and lock cylinder 3, is rotatably engaged with the lock cylinder base 4, and the lock cylinder 3 is rotatable along the interior annular surface 42 of the lock cylinder base 4. In FIG. 11a, the annular protrusions 310a and 310b of the lock cylinder 3 are shown to be in contact with the resilient obstructions 41a and 41b of the lock cylinder base 4. In this regard, the lock cylinder structure is in a normal operational position in which CW rotation of the lock cylinder 3, applied by means of an inserted key, is transferred to the latch to move it to the unlocked position. This normal operational position applies as long as the force applied by a user to rotate the lock cylinder structure further in the CW direction, or a force applied in the opposite CCW direction, is insufficient to cause the lock cylinder structure to rotate beyond the respective extreme position i.e., the force applied is not an overload force. The latch 5 may therefore be operated between the locked and unlocked positions.

FIG. 11b depicts the position of the lock cylinder 3 in the lock cylinder base 4 shortly after an overload force has been applied to rotate the key and lock cylinder structure. Here, annular protrusion member 310a is shown to have moved across resilient obstruction 41a when rotated in a CW direction beyond the extreme position of the latch with an overload force. Annular protrusion 310b has likewise rotated with the lock cylinder structure and may no longer be seen in contact with resilient obstruction 41b. As discussed above, when the force applied by the user to rotate the key and the lock cylinder is an overload force, resilient obstructions 41a and 41b will give way and permit the annular protrusion members 310a and 310b to continue rotating along the interior annular surface 42 of the lock cylinder base 4, thereby temporarily disconnecting from the latch 5 so that the latch 5 is not rotated along with the lock cylinder structure beyond the extreme positions.

In the embodiments shown, the resiliency of the resilient obstructions is achieved by a combination of a choice of a material, which is resiliently deformable, and design and/or dimensions of the resilient obstructions. In the embodiments shown, the parts comprising the resilient obstructions i.e. the housing and the lock cylinder base, and possibly also other parts of the lock assembly, may be moulded parts made of a suitable thermoplastic material. Suitable thermoplastic materials are well-known to the skilled person. In alternative embodiments, the resilient obstructions could also be formed by, for example, spring-mounted parts, bent metal parts (leaf springs), components that move in a predetermined manner relative to one another, or in other ways.

In the embodiments shown, the latch is engaged by the lock cylinder structure for operation between locked and unlocked positions. In alternative embodiments, the latch may be adapted for the being engaged by the key, or other rotation means, inserted into the lock cylinder structure for operation between the locked position and the unlocked position.

In the embodiments shown, the lock cylinder structure is adapted for receiving a key as rotation means for rotating the lock cylinder structure. Other rotation means are envisaged within the scope of the present disclosure, namely in general any insert part which is adapted for being inserted into and/or mating with the lock cylinder structure and possibly the latch and by which the latch is operable from the locked position to the unlocked position.

It is foreseen that the embodiments described herein may be used in combination with and/or for use in a dispenser, and more particularly a dispenser comprising a dispenser housing having an interior volume adapted for holding a dispensable product, such as, but not limited to, paper towel products, soaps, paper tissues, and the like. It is further envisioned that such dispensers have an openable portion to provide access to the interior such that the dispensable product may be refilled and/or removed periodically, either in part or in entirety.

It is to be understood that the disclosure is not limited to the embodiments described above but may be varied within scope as consistent with the spirit of the disclosure.

1. A dispenser comprising a dispenser housing having an interior volume for holding a dispensable product, the housing having an openable part to provide access to the interior volume for refilling the dispensable product, and a lock structure for locking the openable part, the lock structure comprising:
a lock housing comprising a central annular opening,
a latch operable between a locked position and an unlocked position,
a lock cylinder structure, rotatably housed in the central annular opening and adapted for being rotated by a rotation means, the lock cylinder structure comprising a rotation means insert portion for receiving the rotation means, and
a resilient member biasing the latch towards the locked position,
wherein the lock structure is provided with an overload protection mechanism formed by at least one resilient obstruction which is positioned to define an extreme position for a part of the lock cylinder structure or the rotation means inserted therein, corresponding to the locked or unlocked position of the latch, and which is adapted to give way to said part upon experiencing an overload force and allow said part to move beyond the extreme position.

2. The dispenser according to claim 1, wherein the overload protection mechanism comprises a first set of resilient obstructions which are arranged to interlock the lock cylinder structure or the rotation means inserted therein with the latch and release the latch from the lock cylinder structure or the rotation means inserted therein upon experiencing the overload force.

3. The dispenser according to claim 1, wherein the latch is adapted for the being engaged by the rotation means inserted into the lock cylinder structure for said operation between the locked position and the unlocked position.

4. The dispenser according to claim 1, wherein the latch is adapted for the being engaged by the the lock cylinder structure for said operation between the locked position and the unlocked position.

5. The dispenser according to claim 4, wherein the lock cylinder structure comprises
a lock cylinder base, to which the latch is connected, and
a lower ring to which the insert portion is connected,
wherein the lower ring is configured to rotatably engage with the lock cylinder base,
wherein the lower ring has two annular protrusions spaced apart from each other along the circumference of the lower ring and
wherein the first set of resilient obstructions are arranged on the lock cylinder base to engage the annular protrusions and thereby block the rotation of the lower ring with respect to the lock cylinder base.

6. The lock structure according to claim 5, wherein the annular protrusions are spaced 180° apart.

7. The dispenser according to claim 1, wherein the overload protection mechanism comprises a second set of resilient obstructions which are arranged to define the extreme positions of the lock cylinder structure with respect to the lock housing.

8. The dispenser according to claim 7, wherein the rotation means insert portion comprises an annular top member having a topside and a bottomside, the topside comprising a slot adapted to receive the rotation means, and the bottomside comprising two protrusion members spaced apart from each other along a portion of a peripheral edge of the bottomside, and wherein the second set of resilient obstructions are provided on the lock housing to obstruct the protrusion members and thereby block the rotation of the key insert portion beyond the extreme positions.

9. The dispenser according to claim 8, wherein the protrusion members are disposed on opposite sides of the peripheral edge of the bottomside.

10. The dispenser according to claim 8, wherein the protrusion members are spaced approximately 180° apart.

11. The dispenser according to claim 7, wherein the second set of resilient obstructions are provided along an interior annular surface of the lock housing and allow rotation of the insert portion between two extreme positions which correspond to the locked and unlocked positions of the latch.

12. The dispenser according to claim 11, wherein the second set of resilient obstructions are spaced approximately 135° apart.

13. The dispenser according to claim 1, wherein each resilient obstruction is a resiliently deformable part.

14. The dispenser according to claim 1, wherein parts of the lock structure comprising one or a set of resilient obstructions are moulded parts made of a suitable thermoplastic material.

15. The dispenser according to claim 1, wherein each resilient obstruction comprises one side having a steep slope defining the extreme position for said part of the lock structure and another side having a lesser slope, such that when said part of the lock structure has passed by the resilient obstruction as a result of the overload force is allowed to be moved back past the obstruction in the opposite direction with little or no obstruction.

16. The dispenser according to claim 1, wherein the rotation means insert portion is a key insert portion for receiving a key as the rotation means for rotating the lock cylinder structure and possibly the latch.

17. A lock assembly, for use with a dispenser, according to claim 1.
